(19) United States
(12) Patent Application Publication
(10) Pub. No.: US 2018/0071854 A1
(43) Pub. Date: Mar. 15, 2018

(54) ACHIEVING HIGH DYNAMIC RANGE IN A DUAL-SPECTRUM DIGITAL IMAGING WELDING HELMET

(71) Applicant: Lincoln Global, Inc., Santa Fe Springs, CA (US)

(72) Inventors: William T. Matthews, Chesterland, OH (US); Douglas Alan Wills, Sagamore Hills, OH (US)

(21) Appl. No.: 15/816,432

(22) Filed: Nov. 17, 2017

Related U.S. Application Data
(63) Continuation-in-part of application No. 14/732,969, filed on Jun. 8, 2015.
Application No. 14/732,969 is a continuation of application No. 13/108,168, filed on May 16, 2011, now Pat. No. 9,073,138.

(51) Int. Cl. B23K 9/32; H04N 7/18; H04N 5/33; H04N 5/265; B23K 9/095; A42B 3/04; A42B 3/22

(52) U.S. Cl. CPC B23K 9/322; H04N 7/183; H04N 5/33; H04N 5/265; A42B 3/225; A42B 3/0433; A42B 3/042; B23K 9/0956

(57) ABSTRACT

Arc welding systems, methods, and apparatus providing dual-spectrum, real-time viewable, enhanced user-discrimination between arc welding characteristics during an arc welding process are disclosed. Welding headgear is configured to shield a user from harmful radiation and to include a digital video camera or cameras to provide dual-spectrum (i.e., both visible spectrum and infrared spectrum) real-time digital video image frames. An exposure controller controls exposure levels of the cameras on a frame-by-frame basis in real-time. The welding headgear is also configured with an optical display assembly for displaying real-time digital video image frames to the user while wearing the headgear. Image processing is performed on the visible and infrared spectrum video image frames to generate dual-spectrum video image frames providing an integrated and optimized view of both the visible and thermal characteristics of the arc welding process which can be viewed by the user on the optical display assembly in real time.

### CROSS-REFERENCE TO RELATED APPLICATIONS AND INCORPORATION BY REFERENCE

This U.S. patent application is a continuation-in-part of and claims the benefit of U.S. non-provisional patent application Ser. No. 14/732,969 filed on Jun. 8, 2015, which is incorporated herein by reference in its entirety and which is a continuation of and claims the benefit of U.S. non-provisional patent application Ser. No. 13/108,168 filed on May 16, 2011 (now U.S. Pat. No. 9,073,138), which is incorporated herein by reference in its entirety.

### TECHNICAL FIELD

Certain embodiments relate to the visualization of arc welding characteristics during an arc welding process. More particularly, certain embodiments relate to systems, methods, and apparatus (e.g., a welding helmet) providing dual-spectrum, real-time viewable, enhanced user-discrimination between arc welding characteristics during an arc welding process.

### BACKGROUND

During an arc welding process, various forms of radiation are emitted including light in the visible, infrared, and ultraviolet spectrums. The emitted radiation may be of high intensity and can harm the eyes and/or skin of the user if the user is not properly protected. Traditionally, a user wears a conventional welding helmet having a window with one or more protective lenses to reduce the intensity of the radiation to safe levels. However, such protective lenses, while providing adequate protection for the user, reduce the amount of light through the lens and do not allow the user to see the visible characteristics of the arc welding process in an optimal manner. For example, certain visible characteristics of the arc and/or the molten metal puddle may be filtered out which the user would prefer to see, or smoke from the arc welding process may obscure the arc and/or the molten metal puddle during portions of the process. Furthermore, such protective lenses do not allow the user to see the thermal or infrared characteristics of the arc, the puddle, or the surrounding metal at all. Also, users that require corrective lenses are disadvantaged when using conventional helmets and are restricted to using a few “cheater” lenses that provide some magnification.

Further limitations and disadvantages of conventional, traditional, and proposed approaches will become apparent to one of skill in the art, through comparison of such approaches with embodiments of the present invention as set forth in the remainder of the present application with reference to the drawings.

### SUMMARY

Arc welding systems, methods, and apparatus that provide dual-spectrum, real-time viewable, enhanced user-discrimination between arc welding characteristics during an arc welding process are disclosed herein. A welding headgear is configured to shield a user from harmful radiation and to include a digital video camera or cameras to provide dual-spectrum (i.e., both visible spectrum and infrared spectrum) real-time digital video image frames. The welding headgear is also configured with an optical display assembly for displaying real-time digital video image frames to the user while wearing the headgear during an arc welding process. Image processing is performed on the visible and infrared spectrum video image frames to generate dual-spectrum video image frames providing an integrated and optimized view of both the visible and thermal characteristics of the arc welding process which can be viewed by the user on the optical display assembly. As a result, for a given welding process, a user is able to view desired visible and thermal characteristics of the arc welding process. Unwanted characteristics and obstructions are filtered out while wanted characteristics are preserved and enhanced, providing the user with maximum insight and awareness of the arc welding process in real-time. With such maximum insight and awareness, a user may more readily and effectively adapt his welding technique to form a quality weld. For example, a user may be able to more clearly view and understand the “freezing” or solidifying characteristics of a weld puddle and have better instantaneous knowledge of the weld, and thus be able to have more control resulting in a better weld.

In one embodiment, a dual-spectrum digital imaging arc welding system is disclosed which provides enhanced discrimination between arc welding characteristics to a user. The system includes a welding headgear configured to be worn on a head of a user and to shield at least the eyes of the user from spectral radiation emitted by an arc welding process. The system also includes a visible-spectrum digital video camera physically integrated with the welding headgear and configured to provide raw visible-spectrum real-time digital video image frames. The system further includes an infrared-spectrum digital video camera physically integrated with the welding headgear and configured to provide raw infrared-spectrum real-time digital video image frames. The system also includes an exposure controller operatively interfacing with the visible-spectrum digital video camera and the infrared-spectrum digital video camera. The exposure controller in configured to adjust at least one of an exposure level of the visible-spectrum digital video camera or and exposure level of the infrared-spectrum digital video camera on a frame-by-frame basis in real-time, in accordance with an exposure control algorithm executed by the exposure controller. The system further includes an optical display assembly physically integrated with the welding headgear and configured to present real-time digital video images to the user while the user is wearing the welding headgear. The system also includes a vision engine operatively interfacing with the visible-spectrum digital video camera, the infrared-spectrum digital video camera, and the optical display assembly. The vision engine is configured to generate at least one of dual-spectrum real-time digital video image frames from the raw visible-spectrum real-time digital video image frames and the raw infrared-spectrum real-time digital video image frames, enhanced visible-spectrum real-time digital video image frames from the raw visible-spectrum real-time digital video image frames, or enhanced infrared-spectrum real-time digital video image frames from the raw infrared-spectrum real-time digital video image frames.

In one embodiment, the exposure controller is configured to adjust the exposure level of the visible-spectrum digital video camera independently of adjusting the exposure level of the infrared-spectrum digital video camera. In one embodiment, the exposure controller is configured to adjust the exposure level of the visible-spectrum digital video camera in dependence on the exposure level of the infrared-spectrum digital video camera. In another embodiment, the exposure controller is configured to adjust the exposure level of the infrared-spectrum digital video camera in dependence on the exposure level of the visible-spectrum digital video camera. In one embodiment, the exposure controller is configured to adjust the exposure level of the visible-spectrum digital video camera by controlling an adjustment of at least one of an exposure time, an f-number, a sensitivity, or an optical filter of the visible spectrum digital video camera. In one embodiment, the exposure controller is configured to adjust the exposure level of the infrared-spectrum digital video camera by controlling an adjustment of at least one of an exposure time, an f-number, a sensitivity, or an optical filter of the infrared-spectrum digital video camera. In one embodiment, the vision engine is configured to increase a dynamic range of image data within a dual-spectrum real-time digital video image frame of the dual-spectrum real-time digital video image frames by combining at least two of the raw visible-spectrum real-time digital video image frames, acquired at different exposure levels, into a single visible-spectrum image frame. In one embodiment, the vision engine is configured to increase a dynamic range of image data within a dual-spectrum real-time digital video image frame of the dual-spectrum real-time digital video image frames by combining at least two of the raw infrared-spectrum real-time digital video image frames, acquired at different exposure levels, into a single infrared-spectrum image frame. In one embodiment, the system includes a user interface operatively interfacing to at least the exposure controller and configured to allow a user to manually select a dynamic range from a plurality of selectable dynamic ranges. The dynamic range specifies a range of image data to be generated within at least the dual-spectrum real-time digital video image frames.

In one embodiment, a dual-spectrum digital imaging arc welding system is disclosed which provides enhanced discrimination between arc welding characteristics to a user. The system includes a welding headgear configured to be worn on a head of a user and to shield at least the eyes of the user from spectral radiation emitted by an arc welding process. The system also includes a dual-spectrum digital video camera physically integrated with the welding headgear and configured to provide raw visible-spectrum real-time digital video image frames and raw infrared-spectrum real-time digital video frames. The system further includes an exposure controller operatively interfacing with the dual-spectrum digital video camera. The exposure controller is configured to adjust at least one exposure level of the dual-spectrum digital video camera on a frame-by-frame basis in real-time based at least in part on image data of image frames fed back to the exposure controller from the dual-spectrum digital video camera. The system also includes an optical display assembly physically integrated with the welding headgear and configured to present real-time digital video images to the user while the user is wearing the welding headgear. The system further includes a vision engine operatively interfacing with the dual-spectrum digital video camera and the optical display assembly. The vision engine is configured to generate at least one of dual-spectrum real-time digital video image frames from the raw visible-spectrum real-time digital video image frames and the raw infrared-spectrum real-time digital video image frames, enhanced visible-spectrum real-time digital video image frames from the raw visible-spectrum real-time digital video image frames, or enhanced infrared-spectrum real-time digital video image frames from the raw infrared-spectrum real-time digital video image frames.

In one embodiment, the exposure controller is configured to adjust an exposure level of a visible-spectrum portion of the dual-spectrum digital video camera on a frame-by-frame basis in real-time based on an exposure control analyzer of the exposure controller operating on the raw visible-spectrum real-time digital video image frames fed back to the exposure controller from the dual-spectrum digital video camera. In one embodiment, the exposure controller is configured to adjust an exposure level of an infrared-spectrum portion of the dual-spectrum digital video camera on a frame-by-frame basis in real-time based on an exposure control analyzer of the exposure controller operating on the raw infrared-spectrum real-time digital video image frames fed back to the exposure controller from the dual-spectrum digital video camera. In one embodiment, the exposure controller is configured to adjust an exposure level of a visible-spectrum portion of the dual-spectrum digital video camera independently of adjusting an exposure level of an infrared-spectrum portion of the dual-spectrum digital video camera. In one embodiment, the exposure controller is configured to adjust an exposure level of the visible-spectrum portion of the visible-spectrum digital video camera in dependence on an exposure level of the infrared-spectrum portion of the infrared-spectrum digital video camera. In another embodiment, the exposure controller is configured to adjust an exposure level of the infrared-spectrum portion of the infrared-spectrum digital video camera in dependence on an exposure level of the visible-spectrum portion of the visible-spectrum digital video camera. In one embodiment, the exposure controller is configured to adjust an exposure level of a visible-spectrum portion of the dual-spectrum digital video camera by controlling an adjustment of at least one of an exposure time, an f-number, a sensitivity, or an optical filter of the visible-spectrum portion of the dual-spectrum digital video camera. In one embodiment, the exposure controller is configured to adjust an exposure level of an infrared-spectrum portion of the dual-spectrum digital video camera by controlling an adjustment of at least one of an exposure time, an f-number, a sensitivity, or an optical filter of the infrared-spectrum portion of the dual-spectrum digital video camera. In one embodiment, the vision engine is configured to increase a dynamic range of image data within a dual-spectrum real-time digital video image frame of the dual-spectrum real-time digital video image frames by combining at least two of the raw visible-spectrum real-time digital video image frames, acquired at different exposure levels, into a single visible-spectrum image frame. In one embodiment, the vision engine is configured to increase a dynamic range of image data within a dual-spectrum real-time digital video image frame of the dual-spectrum real-time digital video image frames by combining at least two of the raw infrared-spectrum real-time digital video image frames, acquired at different exposure levels, into a single infrared-spectrum image frame. In one embodiment, the system includes a user interface operatively interfacing to at least the exposure controller and configured to allow a user to manually select a dynamic range from a plurality of selectable dynamic ranges. The dynamic range specifies a range of image data to be generated within at least the dual-spectrum real-time digital video image frames.

These and other features of the claimed invention, as well as details of illustrated embodiments thereof, will be more fully understood from the following description and drawings.

### BRIEF DESCRIPTION OF THE DRAWINGS

FIG. 1 is an illustration of a first example embodiment of a dual-spectrum digital imaging arc welding system for providing enhanced discrimination between arc welding characteristics;

FIG. 2 is an illustration of an exploded view of the system of FIG. 1 showing various elements of the system;

FIG. 3 is a schematic block diagram of the embodiment of the dual-spectrum digital imaging arc welding system of FIG. 1 and FIG. 2 showing various imaging elements;

FIG. 4 is a schematic block diagram of an example embodiment of a vision engine used in the system of FIGS. 1-3;

FIG. 5 is a flowchart of an embodiment of a method of generating enhanced dual-spectrum real-time digital video of a welding process using the system of FIGS. 1-4;

FIG. 6 is a schematic block diagram of a second example embodiment of a dual-spectrum digital imaging arc welding system providing enhanced user-discrimination between arc-welding characteristics;

FIG. 7 is a schematic block diagram of a third example embodiment of a dual-spectrum digital imaging arc welding system providing enhanced user-discrimination between arc-welding characteristics;

FIG. 8 is a schematic block diagram of another embodiment of a dual-spectrum digital imaging arc welding system showing various imaging and control elements;

FIG. 9 is a schematic block diagram of yet another embodiment of a dual-spectrum digital imaging arc welding system showing various imaging and control elements; and

FIG. 10 illustrates an embodiment of an example exposure controller that may be used as the exposure controller in the systems of FIG. 8 and FIG. 9.

### DETAILED DESCRIPTION

Embodiments of the present invention are concerned with systems, methods, and apparatus providing dual-spectrum (e.g., visible-spectrum and infrared-spectrum), real-time viewable, enhanced visibility of arc welding characteristics during an arc welding process. In accordance with certain embodiments of the present invention, such capability is provided in a dual-spectrum welding helmet worn by the user performing the welding process.

As used herein, the term “physically integrated” refers to being positioned on, being an integral part of, or being attached to (with or without the capability to be subsequently unattached). As used herein, the term “real-time” refers to significantly maintaining the temporal characteristics of an imaged welding process scene with minimal or largely imperceptible delay between image capture and display.

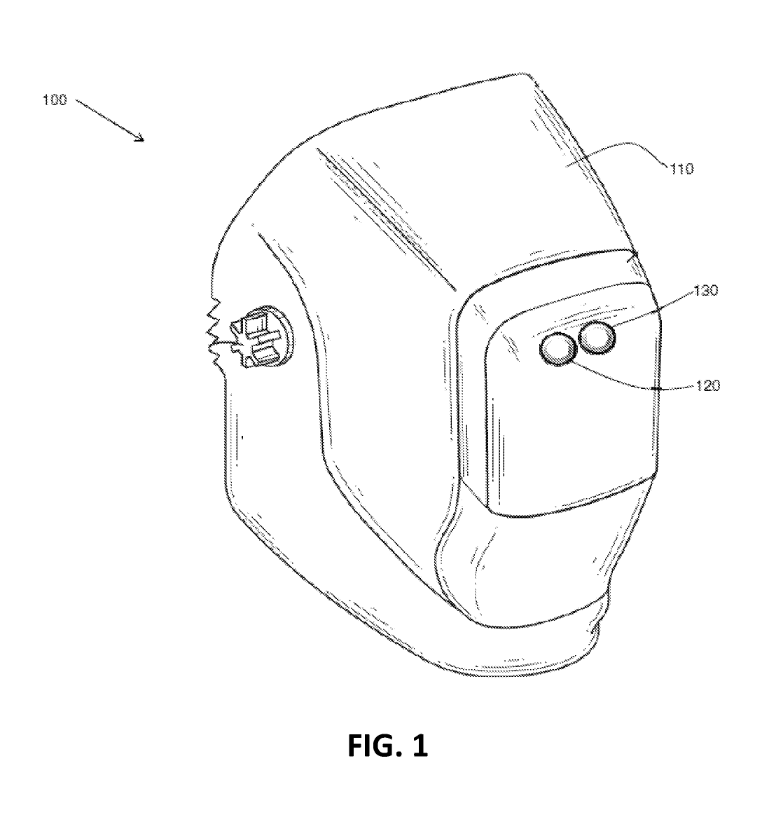

Details of various embodiments of the present invention are described below herein with respect to FIGS. 1-10. FIG. 1 is an illustration of a first example embodiment of a dual-spectrum digital imaging arc welding system 100 for providing enhanced discrimination between arc welding characteristics to a user. The system 100 of FIG. 1 includes a welding helmet (welding headgear) or a welding shield 110 that is worn by a welder during a welding process. The welding helmet 110 does not have a window with, for example, a glass filter lens, as certain conventional welding helmets have. Instead, the system 100 includes a welding helmet 110 that has digital imaging technology integrated into the helmet 110 to capture and display desired aspects of the welding process scene to the welder. Both visible-spectrum (VS) and infrared-spectrum (IRS) energy from the welding process are sensed through a VS lens 120 and an IRS lens 130, respectively on the front of the helmet 110.

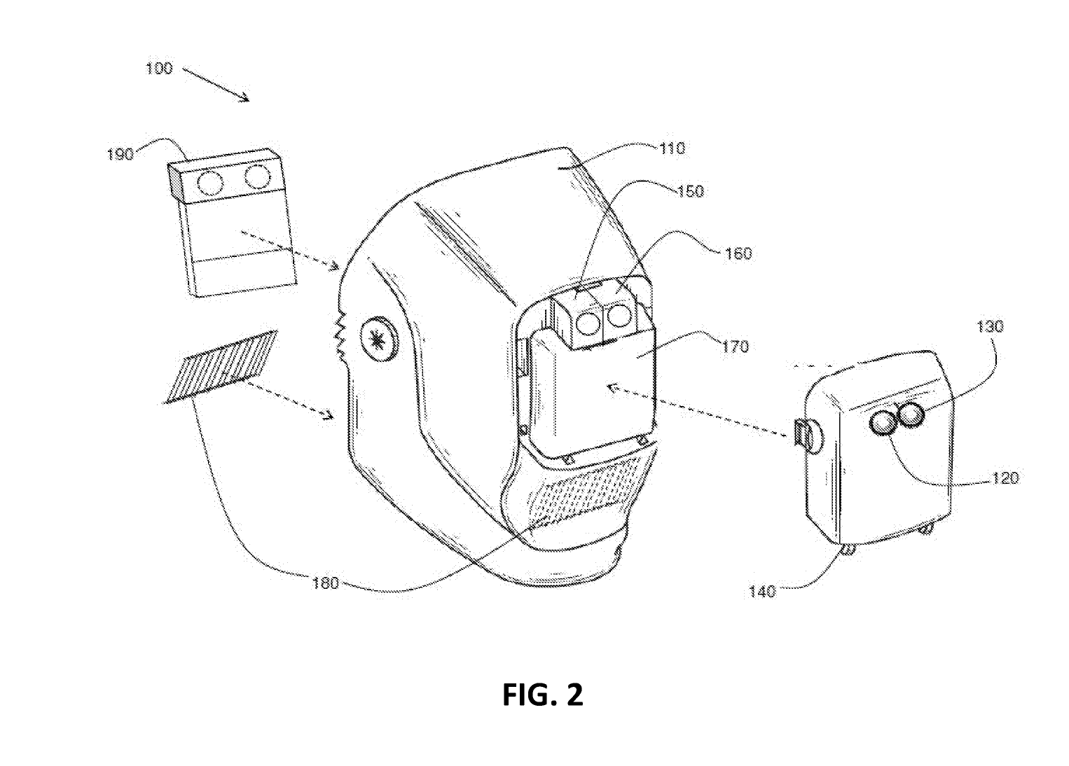

FIG. 2 is an illustration of an exploded view of the system 100 of FIG. 1 showing various elements of the system 100, including various imaging elements that are physically integrated into the welding helmet 110. The system 100 includes a removable lens cover 140 having the VS lens 120 and the IRS lens 130. The lens cover 140 attaches to the helmet 110 at the front of the helmet 110. When removed, the lens cover 140 reveals a visual-spectrum (VS) digital video camera 150, an infrared-spectrum (IRS) digital video camera 160, and a vision engine 170. When the lens cover 140 is attached to the helmet 110, the lenses 120 and 130 operatively integrate with their respective cameras 150 and 160 which are used to simultaneously capture visible-spectrum light and infrared-spectrum light from a welding process scene, and generate raw visible-spectrum (VS) real-time digital video image frames and raw infrared-spectrum (IRS) real-time digital video image frames. In accordance with an embodiment of the present invention, the cameras 150 and 160 are high-definition, high speed video cameras capable of generating image frames in real-time. Furthermore, the cameras 150 and 160 may provide either grayscale or color pixel information, in accordance with various embodiments of the present invention.

The system 100 also includes a vision engine 170 that operatively interfaces with the cameras 150 and 160. The vision engine 170 receives the raw VS and IRS real-time digital video image frames from the cameras 150 and 160 and performs image processing on the digital video image frames to create dual-spectrum (DS) real-time digital video image frames which combine desired VS and IRS image attributes from the respective VS and IRS imaging frames. As described later herein in more detail, the vision engine 170 first generates pre-processed VS and IRS digital video image frames from the corresponding raw digital video image frames and then proceeds to generate the DS real-time digital video image frames from the pre-processed VS and IRS frames. In accordance with an embodiment of the present invention, the welder may choose to view the DS, pre-processed VS, or pre-processed IRS real-time digital video image frames during the welding process.

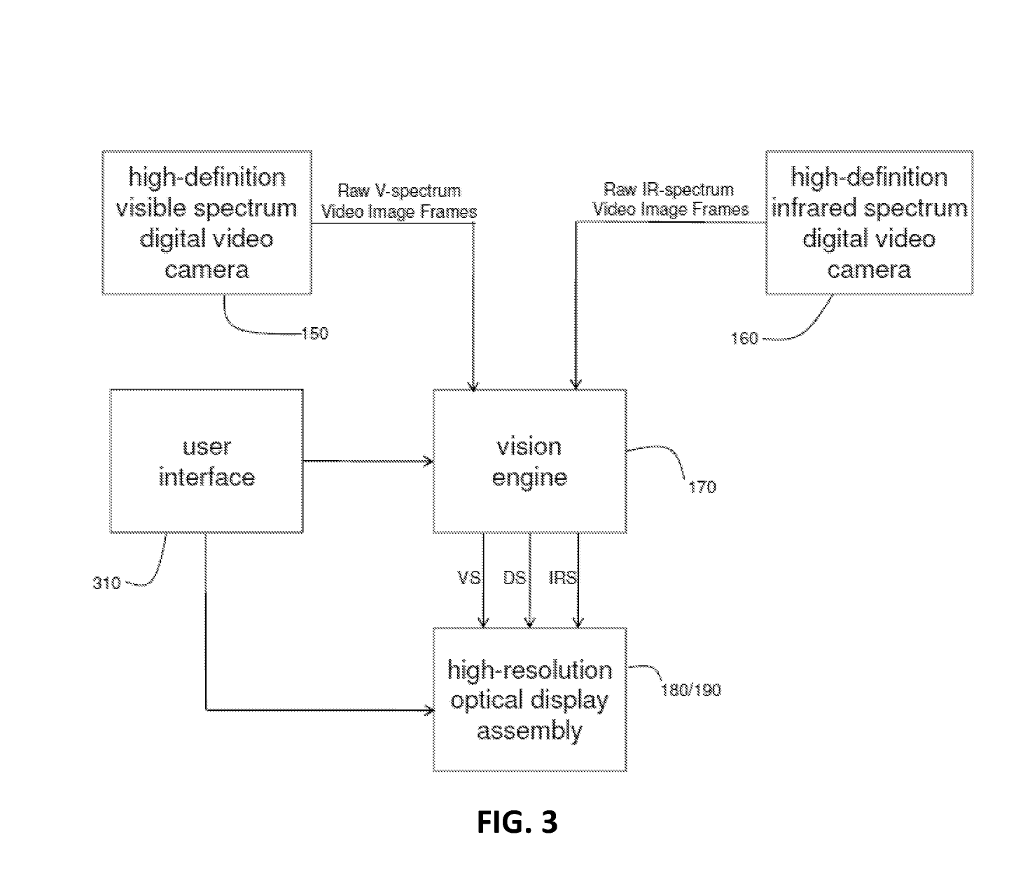

The system 100 further includes an optical display assembly comprising an LCD display 180 and a set of optics 190. The LCD display 180 operatively interfaces to the vision engine 170 to receive processed real-time digital video (e.g., DS real-time digital video image frames) from the vision engine 170. In accordance with an embodiment of the present invention, the LCD display 180 is a full-color high-resolution display capable of being updated in real-time. The optics 190 operatively interfaces to the LCD display 180 to project the processed real-time digital video to the eyes of the welder within the helmet 110. In accordance with an embodiment of the present invention, the optics 190 includes a configuration of high resolution reflective mirrors, optical lenses, and electronics that is configured to focus the welding process scene such that the welding process scene appears at a correct distance from the welder. The optics 190 may provide other capabilities as well including, for example, a zoom feature. Such a feature may be selectable via a user interface (see schematic element 310 of FIG. 3) operatively interfacing to the optical display assembly.

FIG. 3 is a schematic block diagram of the embodiment of the dual-spectrum digital imaging arc welding system 100 of FIG. 1 and FIG. 2 showing various imaging elements. As illustrated in FIG. 3, the VS digital video camera 150 provides raw VS video image frames to the vision engine 170. Similarly, the IRS digital video camera 160 provides raw IRS video image frames to the vision engine 170. The term “raw” is used herein to mean that the video image frames have only been optically and electronically processed by the cameras 150 and 160 and not yet by the vision engine 170, and that the video image frames out of the cameras 150 and 160 are highly representative of all aspects of the welding process scene including both wanted and unwanted attributes of the scene. That is, the raw video image frames have not yet been processed by the vision engine 170 to enhance those attributes that the welder desires to view, and to remove those attributes that the welder does not desire to view (e.g., obstructions). However, the lenses 120 and 130 and/or the cameras 150 and 160 may provide some optical filtering to, for example, cut down on glare from the arc.

The vision engine 170, upon receiving the raw VS and IRS digital video image frames from the cameras 150 and 160, proceeds to process the raw image frames to produce dual-spectrum (DS) real-time digital video image frames (i.e., image frames that combine both visible-spectrum information and infrared-spectrum information from the original raw image frames) which largely maintain the desirable real-time characteristics of the welding process scene. The DS real-time digital video image frames are provided to the optical display assembly 180/190 for viewing by the welder.

In accordance with an embodiment of the present invention, the vision engine is configured to also generate enhanced visible-spectrum (VS) real-time digital video image frames and enhanced infrared-spectrum (IRS) real-time digital video image frames. As a result, a welder (user) is able to select, via the user interface 310, which of the three types of video (DS, enhanced VS, enhanced IRS) to display on the optical display assembly. Furthermore, in accordance with an embodiment of the present invention, the system 100 is configured to allow a user to select an imaging mode from a plurality of selectable and pre-defined imaging modes via the user interface 310. In accordance with various embodiments of the present invention, the user interface 310 may be integrated into the welding helmet 110 (e.g., as push-buttons on the side of the helmet), or may be a physically separate apparatus that interfaces in a wired or wireless manner with the helmet.

An imaging mode corresponds to a pre-defined configuration of image processing to be performed by the vision engine. For example, one imaging mode may be defined to display infrared-spectrum information associated with the molten welding puddle and visible-spectrum information associated with the arc. Similarly, another imaging mode may be defined to display visible-spectrum information associated with the molten welding puddle and infrared-spectrum information associated with the arc. Still, another imaging mode may be defined to display blended visible-spectrum and infrared-spectrum information associated with the molten metal puddle, infrared-spectrum information associated with the metal workpiece away from the molten metal puddle, and visible-spectrum information associated with the electrode wire and the arc. Many other imaging modes are possible as well.

In accordance with an embodiment of the present invention, the system 100 is configured to allow a user to change an imaging parameter preset to one of a plurality of selectable and pre-defined imaging parameter presets. An imaging parameter preset corresponds to a pre-defined setting of an imaging parameter. For example, one imaging parameter preset may be a color map. The system 100 may provide a plurality of color maps that a user may select when viewing, for example, infrared-spectrum information. Another imaging parameter preset may be a level of spatial filtering or smoothing. The system 100 may provide a plurality of levels of spatial filtering that a user may select when viewing, for example dual-spectrum information. Still, another imaging parameter preset may be a level of temporal filtering or smoothing. The system 100 may provide a plurality of levels of temporal filtering that a user may select in order to, for example, filter out obstructing smoke from the displayed video.

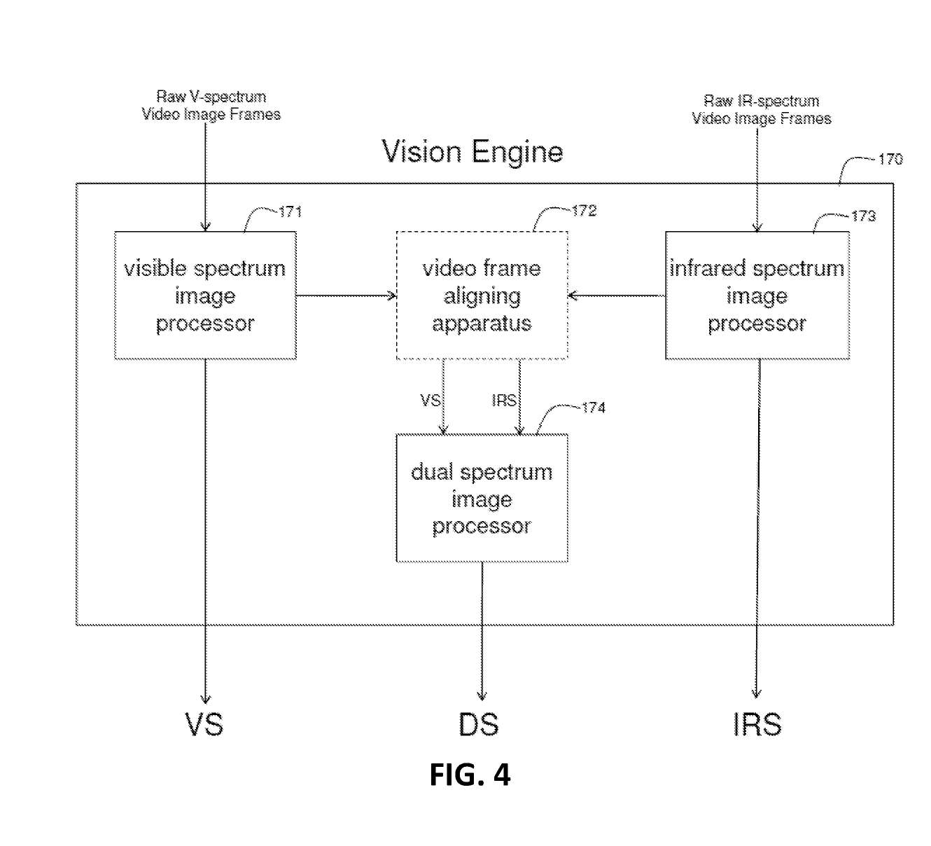

FIG. 4 is a schematic block diagram of an example embodiment of a vision engine 170 used in the system 100 of FIGS. 1-3. The vision engine 170 takes the raw VS video image frames, from the VS video camera 150, into a first visible-spectrum (VS) image processor 171. The VS image processor 171 operates on the raw VS video image frames to generate processed (or pre-processed) VS video image frames. The raw VS video image frames are processed by the VS image processor 171 to enhance the usable visible-spectrum information (e.g., certain visible characteristics of the welding arc) in the video frames and to remove unwanted information (e.g., smoke). The various image processing functions that may be performed by the VS image processor 171 include, for example, spatial filtering, thresholding, temporal filtering, spectral filtering, contrast enhancement, edge enhancement, and color mapping. Other types of image processing functions are possible as well, in accordance with various other embodiments of the present invention.

Similarly, the vision engine 170 takes the raw IRS video image frames, from the IRS video camera 160, into a second infrared-spectrum (IRS) image processor 173. The IRS image processor 173 operates on the raw IRS video image frames to generate processed (or pre-processed) IRS video image frames. The raw IRS video image frames are processed by the IRS image processor 173 to enhance the usable infrared-spectrum information in the video frames (e.g., certain thermal characteristics of the molten metal puddle) and to remove unwanted information (e.g., background temperature of a workpiece). Similarly, the various image processing functions that may be performed by the IRS image processor 173 include, for example, spatial filtering, thresholding, temporal filtering, spectral filtering, contrast enhancement, edge enhancement, and color mapping. Other types of image processing functions are possible as well, in accordance with various other embodiments of the present invention. The image processors may include buffers and memory for passing image frames in and out, and for temporarily storing processed image frames at various intermediate steps, for example.

The resultant enhanced VS and IRS real-time digital video image frames may be output to the optical display assembly 180/190 for display to the user (e.g., upon user selection of one or the other) and/or provided to a third dual-spectrum (DS) image processor 174 to generate combined dual-spectrum (DS) real-time digital image video frames. In accordance with an embodiment of the present invention, the video frames coming into the vision engine 170 from the cameras 150 and 160 are assumed to be temporally aligned or correlated. That is, both cameras 150 and 160 operate at a same acquisition frame rate and, therefore, any image frame coming into the VS image processor 171 at a particular time is assumed to correspond in time to an image frame coming into the IRS image processor 173 at that same particular time. However, in accordance with certain other embodiments, the VS image processor 171 and/or the IRS image processor 173 may be “tuned”, “tweaked”, or calibrated to temporally align the video frames of one to the other. Alternatively, a separate video frame temporal aligning apparatus may be provided in the vision engine to temporally align the VS and IRS image frames.

Furthermore, as can be seen from FIG. 1, the lenses 120 and 130 are spatially offset from each other on the lens cover 140. This may result in a certain amount of spatial misalignment between the pixels of a VS image frame and the pixels of an IRS image frame that are otherwise temporally correlated or aligned. In accordance with an embodiment of the present invention, the lenses 120 and 130 are positioned and calibrated to make sure that raw VS image frames are spatially aligned with the raw IRS video image frames. Such calibration techniques are well known in the art.

However, as an option, the temporally aligned VS and IRS video frames out of the respective image processors 171 and 173 may be spatially aligned by an optional video frame aligning apparatus 172. The video frame aligning apparatus 172 uses a spatial aligning algorithm to spatially line up or match the pixels of a VS frame to an IRS frame before providing the frames to the DS image processor 174. Such a spatial aligning algorithm may be anything from a sophisticated algorithm that implements state-of-the-art aligning techniques to a simple offset routine that simply applies a known, calibrated offset to the image frames in one or more spatial directions. Such aligning techniques are well-known in the art.

Once the enhanced (i.e., processed) VS and IRS video frames are provided to the DS image processor 174, the DS image processor 174 proceeds to process temporally correlated pairs of VS and IRS image frames to produce DS image frames, containing both visual-spectrum and infrared spectrum information in each video frame. The DS image processor 174 performs image processing on the pairs of image frames on a pixel-by-pixel basis to decide if a given DS pixel derived from a given pair of image frames should contain VS information, IRS information, or some blended combination of the two.

Various image processing decision making algorithms may be applied to make the VS/IRS pixel decision. For example, one image processing algorithm may be configured to assign IRS information to those pixels having IRS data falling within a defined thermal range, and assigning VS information to all other pixels falling outside of that thermal range. This may be the case when it is known that the thermal characteristics of the molten metal puddle of the selected welding process are very different from the thermal characteristics of the arc. As a result, the thermal characteristics of the puddle can be discriminated from the thermal characteristics of the arc. The thermal characteristics of the puddle may be displayed to the user while displaying enhanced visual characteristics of the arc, or vice-versa.

Furthermore, just as for the image processors 171 and 173, the various image processing functions that may be performed by the DS image processor 174 may include, for example, spatial filtering, thresholding, temporal filtering, spectral filtering, contrast enhancement, edge enhancement, and color mapping. Other types of image processing functions are possible as well, in accordance with various other embodiments of the present invention.

Even if the raw image data from the cameras is in the form of grayscale data, the resultant DS images (and enhanced VS and IRS images) can be color coded by applying color maps to the pixel data. The various image processors 171, 173, and 174 may be, for example, digital signal processors (DSPs) or programmable processors running image processing software, in accordance with various embodiments of the present invention. Other types of processors may be possible as well, in accordance with other embodiments of the present invention. The image processing is done in real time so as to largely maintain the real-time or temporal characteristics of the imaged welding process scene.

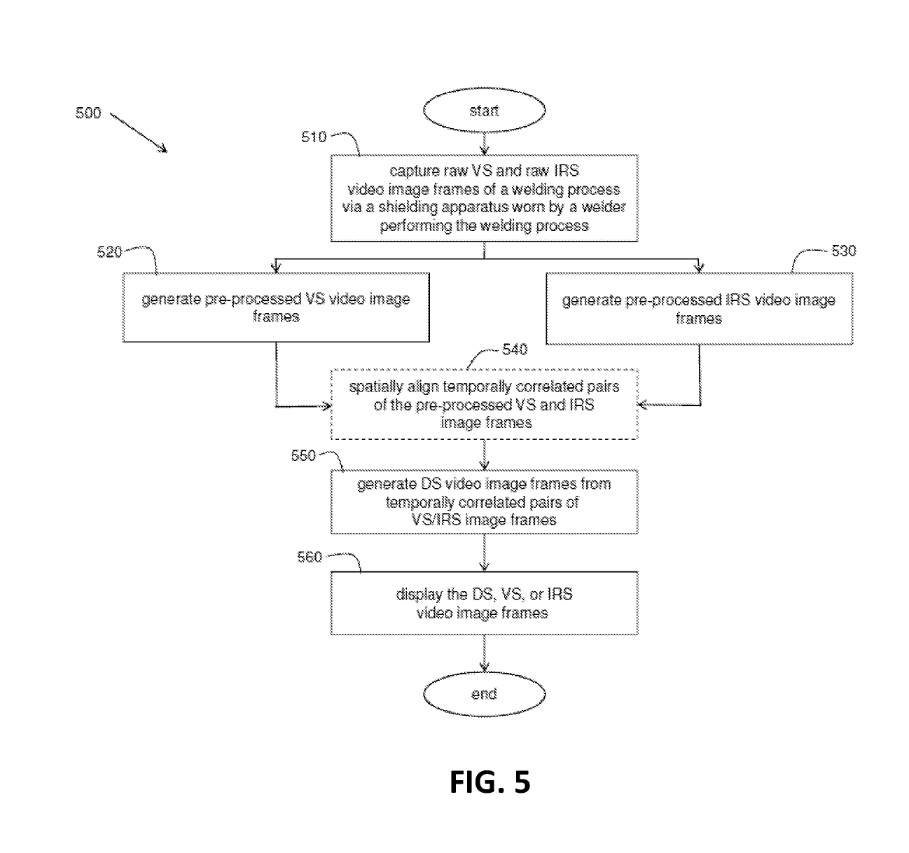

FIG. 5 is a flowchart of an embodiment of a method 500 of generating enhanced dual-spectrum real-time digital video of a welding process using the system 100 of FIGS. 1-4. In step 510 of the method 500, raw VS and raw IRS real time digital video image frames of a welding process are captured via a shielding apparatus worn by a welder performing the welding process to shield the welder from harmful radiation (e.g., bright visible light, heat, ultraviolet light) emitted by the welding process. In step 520, the raw VS real-time digital video image frames are pre-processed to generate pre-processed VS real-time digital video image frames by maintaining and enhancing desired visual-spectrum attributes of the welding process and by removing unwanted visual-spectrum attributes of the welding process.

In step 530, the raw IRS real-time digital video image frames are pre-processed to generate pre-processed IRS real-time digital video image frames by maintaining and enhancing desired infrared-spectrum attributes of the welding process and by removing unwanted infrared-spectrum attributes of the welding process. In step 540 (an optional step), temporally correlated pairs of VS and IRS pre-processed image frames are spatially aligned. In step 550, the temporally correlated pairs of image frames of the pre-processed VS and IRS image frames are further processed to generate dual-spectrum (DS) real-time digital video image frames. In step 560, one of the DS real-time digital video image frames, the pre-processed VS real-time digital video image frames, and the pre-processed IRS real-time digital video image frames is displayed to the welder via the shielding apparatus (e.g., via the optical display assembly 180/190 integrated into the helmet 110) as the welder wears the shielding apparatus during the welding process. Again, the user may select which video channel (VS, IRS, or DS) is to be displayed. Again, each pixel of each frame of the DS real-time digital video image frames corresponds to visual-spectrum information, infrared-spectrum information, or a blending of visual-spectrum information and infrared-spectrum information.

In accordance with an embodiment of the present invention, particular image processing functions performed as part of the pre-processing of the raw VS real-time digital video image frames are selectable from a plurality of image processing options. Similarly, particular image processing functions performed as part of the pre-processing of the raw IRS real-time digital video image frames are selectable from a plurality of image processing options. Furthermore, particular image processing functions performed as part of the processing to generate the DS real-time digital video image frames are selectable from a plurality of image processing options. Also, in accordance with an embodiment of the present invention, particular image processing functions performed as part of the pre-processing steps and the processing step of the method 500 are dependent on selection of a welding process from a plurality of welding processes.

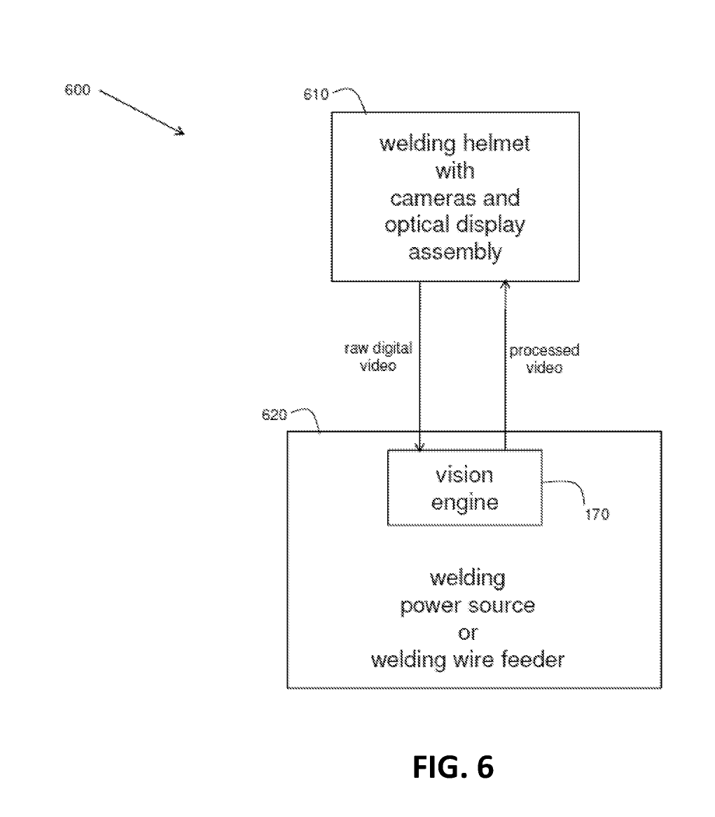

FIG. 6 is a schematic block diagram of a second example embodiment of a dual-spectrum digital imaging arc welding system 600 providing enhanced user-discrimination between arc-welding characteristics for a user. The system 600 includes a welding helmet 610 having the lenses, cameras, and the optical display assembly of FIG. 2 physically integrated therewith. However, the system 600 also includes a welding power source and/or a welding wire feeder 620. In the embodiment of FIG. 6, the vision engine 170 is no longer physically integrated with the welding helmet but is, instead, integrated into the welding power source or the welding wire feeder. In such an embodiment, raw digital video (both VS and IRS) is sent from the cameras of the welding helmet to the vision engine 170 via wired or wireless means. Processed video (DS, VS, and IRS) is sent from the vision engine 170 back to the welding helmet via wired or wireless means. The configuration of FIG. 6 may be desirable if, for example, the vision engine 170 would take up too much space within the helmet, or if the vision engine would cause the helmet to weigh too much if integrated into the helmet. Alternatively, the vision engine could be mounted on the outside of the helmet such as, for example, on the top of the helmet to save space interiorly. The vision engine 170 may receive information from the welding power source and/or welding wire feeder 710 such as, for example, current selected welding mode, current electrode type, or current selected welding waveform and/or polarity. Such information may be used by the vision engine 170 to make image processing selections or decisions. Furthermore, a user interface may be integrated into the welding power source or the welding wire feeder to allow a user to select imaging modes, imaging parameter presets, etc.

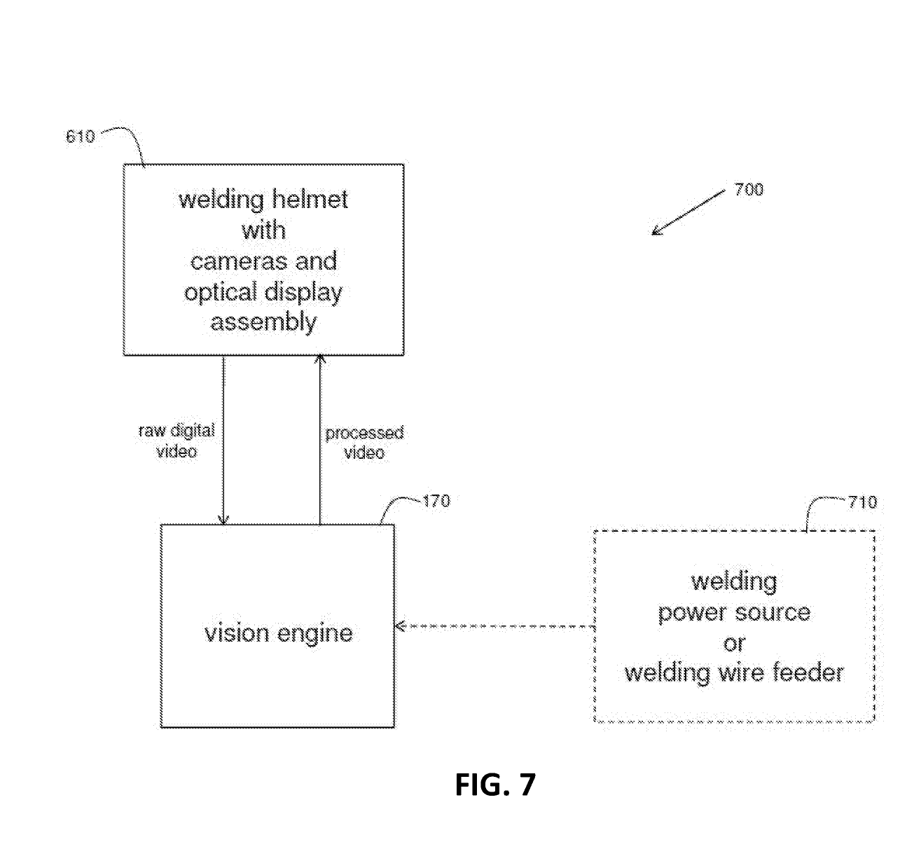

FIG. 7 is a schematic block diagram of a third example embodiment of a dual-spectrum digital imaging arc welding system 700 providing enhanced user-discrimination between arc-welding characteristics for a user. The system 700 includes a welding helmet 610 having the lenses, cameras, and the optical display assembly of FIG. 2 physically integrated therewith. However, the vision engine 170 is physically separate from the helmet. In such an embodiment, raw digital video (both VS and IRS) is sent from the cameras of the welding helmet to the vision engine 170 via wired or wireless means. Processed video (DS, VS, and IRS) is sent from the vision engine 170 back to the welding helmet via wired or wireless means. The configuration of FIG. 7 may be desirable if, for example, the vision engine 170 would take up too much space within the helmet, or if the vision engine would cause the helmet to weigh too much if integrated into the helmet. Again, alternatively, the vision engine could be mounted on the outside of the helmet such as, for example, on the top of the helmet to save space interiorly. As an option, the vision engine 170 may interface to a welding power source and/or welding wire feeder 710 (e.g., wired or wirelessly) to, again, receive information from the welding power source and/or welding wire feeder 710 such as, for example, current selected welding mode, current electrode type, or current welding waveform and/or polarity. Such information may be used by the vision engine 170 to make image processing selections or decisions. Furthermore, a user interface may be integrated into the vision engine to allow a user to select imaging modes, imaging parameter presets, etc.

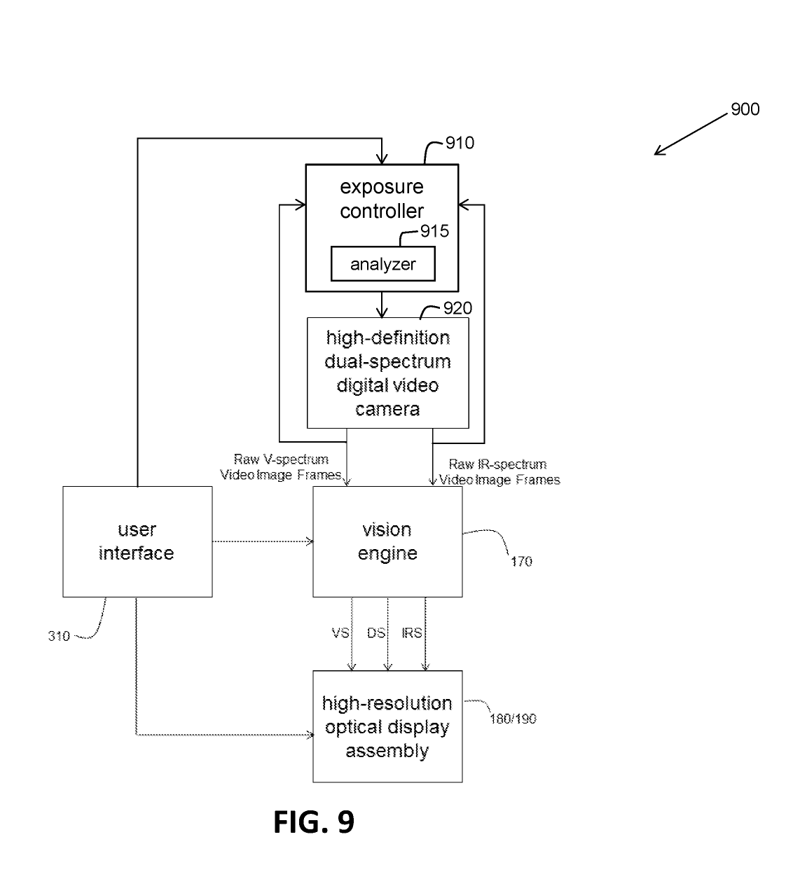

In accordance with an alternative embodiment of the present invention, the system may include a single dual-spectrum digital video camera and a single lens, where the single camera and lens is able to sense both visible-spectrum and infrared-spectrum radiation. For example, the single camera may include a visible-spectrum sensor array interleaved with an infrared-spectrum sensor array, allowing simultaneous capture and formation of both VS and IRS image frames. Alternately, the single camera may alternate between capturing visible-spectrum data and infrared-spectrum data in a time-shared manner on, for example, a frame-to-frame basis. In both cases, a separate set of VS image frames and IRS image frames are formed and provided to the vision engine 170. In such a single camera system, spatial alignment of VS and IRS image frames is inherently achieved. It is readily apparent from FIGS. 1-3 how the embodiments of FIGS. 1-3 could be modified to such a single-camera configuration. FIG. 9, discussed later herein, illustrates an embodiment of a system using a single dual-spectrum digital video camera and a single lens, where the single camera and lens is able to sense both visible-spectrum and infrared-spectrum radiation.

In accordance with an alternative embodiment of the present invention, the system includes one or more three-dimensional (3D) view cameras, allowing a user to see the arc welding process scene in a 3D manner. The optical display assembly is configured to allow 3D viewing of the welding process scene by the user.

In accordance with an enhanced embodiment of the present invention, non-imaging information may be generated, gathered, and displayed on the display 180. For example, various guide information or help attributes may be overlaid onto the displayed real-time video to aid the user during the welding process. Such non-imaging information may include, for example, gun/torch angle or stick electrode angle, stick out distance from the workpiece, travel speed of the gun/torch or stick electrode, gun/torch height or stick electrode height, and gun/torch angle or stick electrode angle. The non-imaging information may be obtained from another system such as, for example, a virtual reality welding simulation system which is tethered into the system 100 and is configured to spatially track at least the gun/torch or stick electrode. Alternatively, the non-imaging information may be generated by the system 100 by using at least one camera of the system 100 to spatially track the welding gun/torch or stick electrode, for example. In such an embodiment, the system 100 includes a tracking module to perform the spatial tracking functions.

Other non-imaging information may include recommendations (e.g., “speed up”, “slow down”, “adjust angle”, etc.). In fact, in accordance with an embodiment of the present invention, information obtained from the dual-spectrum video may be used to determine the recommendations. For example, if the thermal characteristics of the weld puddle indicate that the temperature of the weld puddle is too low, the system may display a recommendation to the user to slow down the travel speed of the torch to allow more thermal energy to enter into the weld puddle. Other recommendations are possible as well, based on well-known good welding technique and the relationships between resultant weld characteristics and welding technique.

An embodiment of the present invention comprises a dual-spectrum digital imaging arc welding system providing enhanced discrimination between arc welding characteristics. The system includes a welding headgear configured to be worn on a head of a user to shield at least the eyes of the user from spectral radiation emitted by an arc welding process. A visible-spectrum (VS) digital video camera is physically integrated with the welding headgear and configured to provide raw VS real-time digital video image frames representative of the arc welding process within a field-of-view of the VS digital video camera. An infrared-spectrum (IRS) digital video camera is physically integrated with the welding headgear and configured to provide raw IRS real-time digital video image frames representative of the arc welding process within a field-of-view of the IRS digital video camera. An optical display assembly is physically integrated with the welding headgear to present real-time digital video images to the user while the user is wearing the welding headgear. A vision engine operatively interfaces with the VS digital video camera, the IRS digital video camera, and the optical display assembly. The vision engine is configured to produce at least dual-spectrum (DS) real-time digital video image frames from the raw VS and raw IRS real-time digital video image frames and display the DS real-time video image frames to the user via the optical display assembly.

The vision engine may be physically integrated with the welding headgear or may be physically separate from the welding headgear. For example, the system may include a welding power source, wherein the vision engine is physically integrated into and/or operatively interfaces with the welding power source. The system may include a welding wire feeder, wherein the vision engine, instead, is physically integrated into and/or operatively interfaces with the welding wire feeder.

The system may also include a user interface operatively interfacing to at least one of the vision engine and the optical display assembly. The user interface may be configured to allow a user to manually select an imaging mode from a plurality of selectable and pre-defined imaging mode, or may be configured to allow a user to manually change an imaging parameter preset to one of a plurality of selectable and pre-defined imaging parameter presets.

In accordance with an embodiment of the present invention, the vision engine includes a first image processor configured to perform image processing on the raw VS real-time digital video image frames to generate processed VS real-time digital video image frames representative of enhanced VS attributes of the welding process. The vision engine also includes a second image processor configured to perform image processing on the raw IRS real-time digital video image frames to generate processed IRS real-time digital video image frames representative of enhanced IRS attributes of the welding process. The vision engine further includes a third image processor configured to perform image processing on the processed VS real-time digital video image frames and the processed IRS real-time digital video image frames to generate the dual-spectrum (DS) real-time digital video image frames representative of combined VS and IRS attributes of the welding process. The vision system may also include a video frame aligning apparatus configured to spatially align temporally correlated pairs of digital video image frames of the processed VS real-time digital video image frames and the processed IRS real-time digital video image frames before providing the processed real-time digital video image frames to the third image processor.

Another embodiment of the present invention comprises a dual-spectrum digital imaging arc welding system providing enhanced discrimination between arc welding characteristics. The system includes means for shielding at least the eyes of a user from spectral radiation emitted by an arc welding process. The system further includes means for generating raw visual-spectrum (VS) real-time digital video image frames representative of visual-spectrum emissions of the arc welding process, wherein the means for generating raw visual-spectrum (VS) real-time digital video image frames is physically integrated with the means for shielding, and means for generating raw infrared-spectrum (IRS) real-time digital video image frames representative of infrared-spectrum emissions of the arc welding process, wherein the means for generating raw infrared-spectrum (IRS) real-time digital video image frames is physically integrated with the means for shielding. The system further includes means for displaying real-time digital video image frames, wherein the means for displaying is physically integrated with the means for shielding. The system also includes means for producing at least dual-spectrum (DS) real-time digital video image frames from the raw VS and raw IRS real-time digital video image frames and providing at least the DS real-time digital video image frames to the means for displaying.

The means for producing at least dual-spectrum (DS) real-time digital video image frames may be physically integrated with the means for shielding, or may be physically separate from the means for shielding. For example, the system may also include a welding power source wherein the means for producing at least dual-spectrum (DS) real-time digital video image frames is physically integrated into and/or operatively interfaces with the welding power source. The system may further include a welding wire feeder wherein the means for producing at least dual-spectrum (DS) real-time digital video image frames, instead, is physically integrated into and/or operatively interfaces with the welding wire feeder.

The system may further include means for allowing a user to manually select an imaging mode from a plurality of selectable and pre-defined imaging modes and/or means for allowing a user to manually change an imaging parameter preset to one of a plurality of selectable and pre-defined imaging parameter presets.

The means for producing at least dual-spectrum (DS) real-time digital video image frames may include means for performing image processing on the raw VS real-time digital video image frames to generate processed VS real-time digital video image frames representative of enhanced VS attributes of the welding process. The means for producing may also include means for performing image processing on the raw IRS real-time digital video image frames to generate processed IRS real-time digital video image frames representative of enhanced IRS attributes of the welding process. The means for producing may further include means for performing image processing on the processed VS real-time digital video image frames and the processed IRS real-time digital video image frames to generate DS real-time digital video image frames representative of combined VS and IRS attributes of the welding process. The means for producing at least dual-spectrum (DS) real-time digital video image frames may further include means for spatially aligning temporally correlated pairs of digital video image frames of the processed VS real-time digital video image frames and the processed IRS real-time digital video image frames before providing the processed VS and IRS real-time digital video image frames to the means for performing image processing on the processed VS and IRS real-time digital video image frames.

A further embodiment of the present invention comprises a vision engine. The vision engine includes several image processors. A first image processor is configured to perform image processing on raw VS real-time digital video image frames to generate processed VS real-time digital video image frames representative of enhanced VS attributes of a welding process. A second image processor is configured to perform image processing on raw IRS real-time digital video image frames to generate processed IRS real-time digital video image frames representative of enhanced IRS attributes of the welding process. A third image processor is configured to perform image processing on temporally correlated pairs of the processed VS real-time digital video image frames and the processed IRS real-time digital video image frames to generate DS real-time digital video image frames representative of combined VS and IRS attributes of the welding process. The vision engine may further include a video frame aligning apparatus configured to spatially align the temporally correlated pairs of digital video image frames of the processed VS real-time digital video image frames and the processed IRS real-time digital video image frames before providing the processed VS and IRS real-time digital video image frames to the third image processor.

Another embodiment of the present invention comprises a method of generating enhanced dual-spectrum real-time digital video of a welding process. The method includes capturing raw visual-spectrum (VS) and raw infrared-spectrum (IRS) real-time digital video image frames of a welding process via a shielding apparatus worn by a welder performing the welding process to shield the welder from harmful radiation emitted by the welding process. The raw VS real-time digital video image frames are pre-processed to generate pre-processed VS real-time digital video image frames by maintaining and enhancing desired visual-spectrum attributes of the welding process and by removing unwanted visual-spectrum attributes of the welding process. The raw IRS real-time digital video image frames are pre-processed to generate pre-processed IRS real-time digital video image frames by maintaining and enhancing desired infrared-spectrum attributes of the welding process and by removing unwanted infrared-spectrum attributes of the welding process. Temporally correlated pairs of image frames of the pre-processed VS and IRS real-time digital video image frames are then processed to generate dual-spectrum (DS) real-time digital video image frames. One of the DS real-time digital video image frames, the pre-processed VS real-time digital video image frames, and the pre-processed IRS real-time digital video image frames is displayed to the welder via the shielding apparatus as the welder wears the shielding apparatus during the welding process in response to selection by the welder, for example.

In accordance with an embodiment of the present invention, each pixel of each frame of the DS real-time digital video image frames corresponds to one of visual-spectrum information, infrared-spectrum information, and a blending of visual-spectrum information and infrared-spectrum information. The method may further include spatially aligning, on a pixel-by-pixel basis, the temporally correlated pairs of image frames before processing the temporally correlated pairs of image frames to generate the DS real-time digital video image frames.

Particular image processing functions performed as part of the pre-processing of the raw visual-spectrum (VS) real-time digital video image frames may be selectable from a plurality of image processing options. Similarly, particular image processing functions performed as part of the pre-processing of the raw infrared-spectrum (IRS) real-time digital video image frames may be selectable from a plurality of image processing options. Also, particular image processing functions performed as part of the processing to generate the dual-spectrum (DS) real-time digital video image frames may be selectable from a plurality of image processing options. Furthermore, particular image processing functions performed as part of the pre-processing steps and the processing step of the method may be dependent on selecting a welding process form a plurality of welding processes.

Another embodiment of the present invention comprises a dual-spectrum digital imaging arc welding system providing enhanced discrimination between arc welding characteristics to a user. The system includes a welding headgear configured to be worn on a head of a user and to shield at least the eyes of the user from spectral radiation emitted by an arc welding process. The system also includes a dual-spectrum (DS) digital video camera physically integrated with the welding headgear and configured to provide raw visible-spectrum (VS) real-time digital video image frames and raw infrared-spectrum (IRS) real-time digital video image frames. The system further includes an optical display assembly physically integrated with the welding headgear and configured to present real-time digital video images to the user while the user is wearing the welding headgear. The system also includes a vision engine operatively interfacing with the DS digital video camera and the optical display assembly, wherein the vision engine is configured to produce at least dual-spectrum (DS) real-time digital video image frames from the raw VS and raw IRS real-time digital video image frames.

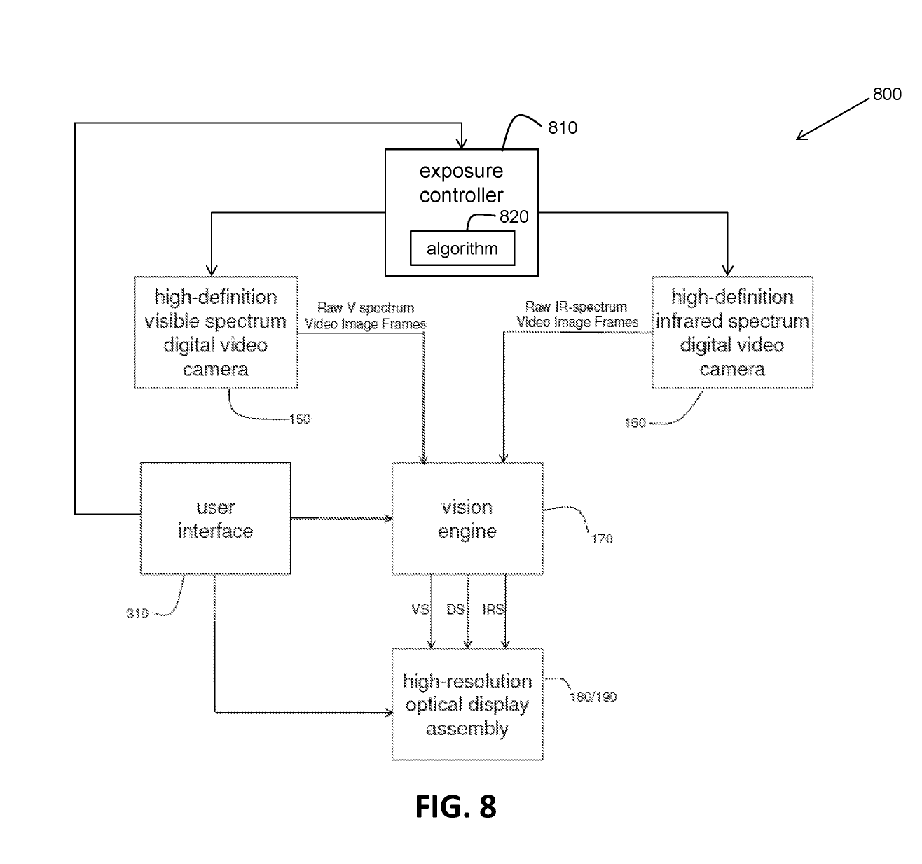

FIG. 8 is a schematic block diagram of another embodiment of a dual-spectrum digital imaging arc welding system 800 showing various imaging and control elements. The system 800 of FIG. 8 is similar to the system 100 of FIGS. 1-3 in that the system 800 includes a visible-spectrum digital video camera 150, an infrared-spectrum digital video camera 160, a vision engine 170, an optical display assembly 180/190, and a user interface 310. However, the system 800 also includes an exposure controller 810 operatively interfacing with the visible-spectrum digital video camera 150, the infrared-spectrum digital video camera 160, and the user interface 310.

The exposure controller 810 is configured to adjust an exposure level of the visible-spectrum digital video camera 150 and an exposure level of the infrared-spectrum digital video camera 160, in accordance with one embodiment. Exposure level of a camera has to do with how much spectral energy is effectively being captured by the camera per frame, which can affect an appearance (e.g., the lightness or darkness) of a resultant image. The exposure level of a camera may be adjusted by adjusting one or more of an exposure time of the camera, a sensitivity of the camera, an optical filter of the camera, or an f-number of the camera. In accordance with one embodiment, the cameras 150 and 160 each have two or more optical filters which may be selected. The f-number is the ratio of the focal length of the camera to the diameter of the effective aperture of the camera. In general, different exposure levels provide corresponding different dynamic ranges of the captured image data. The dynamic range of an image specifies a range of image data within the image (e.g., a range of amplitude values or color values of the pixels in the image).

As shown in FIG. 8, the exposure controller 810 interfaces to the visible-spectrum digital video camera 150 and the infrared-spectrum digital video camera 160 to adjust an exposure level of each. Exposure level may be adjusted on a frame-by-frame basis in real-time, in accordance with one embodiment. Therefore, a first captured image may correspond to a first exposure level, a next second captured image may correspond to a second exposure level, and a still next third captured image may correspond to a third exposure level, and so on. In this manner, a sequence of image frames having different dynamic ranges can be captured. The sequence of image frames may be combined by the vision engine 170 to generate a combined image frame having a dynamic range that is, for example, larger than any of the original individual image frames. An image frame with a larger dynamic range provides more information to a user than a similar image frame with a smaller dynamic range.

In accordance with one embodiment, the adjustment of exposure level is performed in accordance with an exposure control algorithm 820 which is executed by the exposure controller 810. The exposure control algorithm 820 may be implemented within the exposure controller 810 in the form of, for example, hardware (e.g., logic circuits or a digital signal processor), software (e.g., computer-executable instructions running on a processor), firmware (e.g., a programmable and addressable memory, such as an EEPROM, storing a look-up-table (LUT)), or some combination thereof.

In FIG. 8, the exposure control algorithm 820 determines the exposure level for each of a sequence of raw image frames to be acquired by the cameras. For example, in accordance with one embodiment, the exposure control algorithm 820 dictates that, for every three raw images frames acquired in sequence, the first image frame will be acquired at a first exposure level, the second image frame will be acquired at a second exposure level, and the third image frame will be acquired at a third exposure level. The fourth image frame will be acquired at the first exposure level, the fifth image frame will be acquired at the second exposure level, and the sixth image frame will be acquired at the third exposure level, and so on. The vision engine 170 will combine the sequence of every three image frames to form a single image frame (e.g., a single visible-spectrum image frame or a single infrared-spectrum image frame) having a larger dynamic range. Other exposure control algorithms are possible as well, in accordance with other embodiments.

In accordance with one embodiment, a desired overall dynamic range of a resultant image frame acquired by a camera may be selected by a user via the user interface 310 from multiple possible dynamic ranges. A selected dynamic range determines the exposure level(s) of the camera to be set by the exposure controller 810, in accordance with the exposure control algorithm 820. In one embodiment, the dynamic range, and therefore the resultant exposure level(s) of the visible-spectrum digital video camera 150, may be selected independently of the dynamic range, and therefore the resultant exposure level(s), of the infrared-spectrum digital video camera 160. That is, in one embodiment, the exposure controller 810 is configured to adjust the exposure level(s) of the visible-spectrum digital video camera 150 independently of adjusting the exposure level(s) of the infrared-spectrum digital video camera 160.

In one embodiment, the exposure controller 810 is configured to be able to adjust the exposure level(s) of the visible-spectrum digital video camera 150 in dependence on the exposure level(s) of the infrared-spectrum digital video camera 160. For example, in one embodiment, the exposure controller includes a look-up-table (LUT) stored in memory that relates a selected exposure level of the infrared-spectrum digital video camera 160 to an exposure level of the visible-spectrum digital video camera 150. In this manner, when an exposure level(s) is selected for the infrared-spectrum digital video camera 160, an exposure level(s) for the visible-spectrum digital video camera 150 is effectively selected as well.

Similarly, in one embodiment, the exposure controller 810 is configured to be able to adjust the exposure level(s) of the infrared-spectrum digital video camera 160 in dependence on the exposure level(s) of the visible-spectrum digital video camera 150. For example, in one embodiment, the exposure controller 810 includes a look-up-table (LUT) stored in memory that relates a selected exposure level of the visible-spectrum digital video camera 150 to an exposure level of the infrared-spectrum digital video camera 160. In this manner, when an exposure level(s) is selected for the visible-spectrum digital video camera 150, an exposure level(s) for the infrared-spectrum digital video camera 160 is effectively selected as well. Dependencies between the exposure levels of the visible-spectrum digital video camera 150 and the infrared-spectrum digital video camera 160 can be determined by experimentation for various welding processes.

In one embodiment, the vision engine 170 is configured to increase a dynamic range of image data within a resultant dual-spectrum real-time digital video image frame by combining at least two of the raw visible-spectrum real-time digital video image frames, acquired at different exposure levels, into a single visible-spectrum image frame. Therefore, when the vision engine 170 combines the single visible-spectrum image frame (formed from image frames at multiple exposures) with an infrared-spectrum image frame, the resultant dual-spectrum image frame will have a larger dynamic range due to the larger dynamic range of the single visible-spectrum image frame (formed from image frames at multiple exposures).

Similarly, in accordance with another embodiment, the vision engine 170 is configured to increase a dynamic range of image data within a resultant dual-spectrum real-time digital video image frame by combining at least two of the raw infrared-spectrum real-time digital video image frames, acquired at different exposure levels, into a single visible-spectrum image frame. Therefore, when the vision engine 170 combines the single infrared-spectrum image frame (formed from image frames at multiple exposures) with a visible-spectrum image frame, the resultant dual-spectrum image frame will have a larger dynamic range due to the larger dynamic range of the single infrared-spectrum image frame (formed from image frames at multiple exposures).

Furthermore, in accordance with yet another embodiment, the vision engine 170 is configured to increase a dynamic range of image data within a resultant dual-spectrum real-time digital video image frame by combining at least two of the raw infrared-spectrum real-time digital video image frames, acquired at different exposure levels, into a single infrared-spectrum image frame, and by combining at least two of the raw visible-spectrum real-time digital video image frames into a single visible-spectrum image frame. Therefore, the resultant dual-spectrum image frame will have a larger dynamic range due to both of the larger dynamic ranges of the constituent single infrared-spectrum image frame and the single visible-spectrum image frame.

In accordance with one embodiment, the vision engine is configured to also generate enhanced visible-spectrum (VS) real-time digital video image frames and enhanced infrared-spectrum (IRS) real-time digital video image frames. As a result, a welder (user) is able to select, via the user interface 310, which of the three types of video (DS, enhanced VS, enhanced IRS) to display on the optical display assembly. Each video type may include image frames having larger dynamic ranges due to combining image frames acquired at different exposure levels as described herein.

Furthermore, in accordance with one embodiment, the system 100 is configured to allow a user to select an imaging mode from a plurality of selectable and pre-defined imaging modes via the user interface 310. In accordance with various embodiments, the user interface 310 may be integrated into the welding helmet 110 (e.g., as push-buttons on the side of the helmet), or may be a physically separate apparatus that interfaces in a wired or wireless manner with the helmet.

FIG. 9 is a schematic block diagram of yet another embodiment of a dual-spectrum digital imaging arc welding system 900 showing various imaging and control elements. The system 900 of FIG. 9 is similar to the system 800 of FIG. 8 in that the system 900 includes a vision engine 170, an optical display assembly 180/190, a user interface 310, and an exposure controller 910. However, the system 900 includes one camera (a dual-spectrum digital video camera 920 having a single lens) instead of the visible-spectrum digital video camera 150 and the infrared-spectrum digital video camera 160. The dual-spectrum digital video camera 920 is physically integrated with the welding headgear and is configured to provide both the raw visible-spectrum real-time digital video image frames and the raw infrared-spectrum real-time digital video image frames, in accordance with one embodiment. Also, the raw visual-spectrum real-time digital video image frames and the raw infrared-spectrum real-time digital video image frames produced by the dual-spectrum digital video camera 920 are fed back to the exposure controller 910 for analysis.

The dual-spectrum digital video camera 920, having a single lens, is able to sense both visible-spectrum and infrared-spectrum radiation. For example, the dual-spectrum digital video camera 920 may include a visible-spectrum sensor array interleaved with an infrared-spectrum sensor array, allowing simultaneous capture and formation of both VS and IRS image frames. Alternately, the dual-spectrum digital video camera 920 may alternate between capturing visible-spectrum data and infrared-spectrum data in a time-shared manner on, for example, a frame-to-frame basis. In both cases, a separate set of VS image frames and IRS image frames are formed and provided to the vision engine 170. In such a single camera system, spatial alignment of VS and IRS image frames is inherently achieved.

The exposure controller 910 is configured to adjust exposure levels of the dual-spectrum digital video camera 920, in accordance with one embodiment. Again, exposure level of a camera has to do with how much spectral energy is effectively being captured by the camera per frame, which can affect an appearance (e.g., the lightness or darkness) of a resultant image. The exposure level of a camera may be adjusted by adjusting one or more of an exposure time of the camera, a sensitivity of the camera, an optical filter of the camera, or an f-number of the camera. In accordance with one embodiment, the camera 920 has two or more optical filters which may be selected. The f-number is the ratio of the focal length of the camera to the diameter of the effective aperture of the camera. In general, different exposure levels provide corresponding different dynamic ranges of the captured image data. The dynamic range of an image specifies a range of image data within the image (e.g., a range of amplitude values or color values of the pixels in the image).

As shown in FIG. 9, the exposure controller 910 interfaces to the dual-spectrum digital video camera 920 to adjust exposure levels (e.g., an exposure level of a visible-spectrum portion of the dual-spectrum digital video camera 920, and an exposure level of an infrared-spectrum portion of the dual-spectrum digital video camera 920). Exposure level may be adjusted on a frame-by-frame basis in real-time, in accordance with one embodiment. Therefore, a first captured image may correspond to a first exposure level, a next second captured image may correspond to a second exposure level, and a still next third captured image may correspond to a third exposure level, and so on. In this manner, a sequence of image frames having different dynamic ranges can be captured. The sequence of image frames may be combined by the vision engine 170 to generate a combined image frame having a dynamic range that is, for example, larger than any of the original individual image frames. An image frame with a larger dynamic range provides more information to a user than a similar image frame with a smaller dynamic range.

In accordance with one embodiment, a desired overall dynamic range of a resultant image frame acquired by the camera 920 may be selected by a user via the user interface 310 from multiple possible dynamic ranges. A selected dynamic range determines the exposure level(s) of the camera 920 to be set by the exposure controller 910. In one embodiment, the dynamic range, and therefore the resultant exposure level(s), of the visible-spectrum portion of the dual-spectrum digital video camera 920 may be selected independently of the dynamic range, and therefore the resultant exposure level(s), of the infrared-spectrum portion of the dual-spectrum digital video camera 920. That is, in one embodiment, the exposure controller 910 is configured to adjust the exposure level(s) of the visible-spectrum portion of the dual-spectrum digital video camera 920 independently of adjusting the exposure level(s) of the infrared-spectrum portion of the dual-spectrum digital video camera 920.

In one embodiment, the exposure controller 910 is configured to be able to adjust the exposure level(s) of the visible-spectrum portion of the dual-spectrum digital video camera 920 in dependence on the exposure level(s) of the infrared-spectrum portion of the dual-spectrum digital video camera 920. For example, in one embodiment, the exposure controller 910 includes a look-up-table (LUT) stored in memory that relates a selected exposure level of the infrared-spectrum portion of the dual-spectrum digital video camera 920 to an exposure level of the visible-spectrum portion of the dual-spectrum digital video camera 920. In this manner, when an exposure level(s) is selected for the infrared-spectrum portion of the dual-spectrum digital video camera 920, an exposure level(s) for the visible-spectrum portion of the dual-spectrum digital video camera 920 is effectively selected as well.

Similarly, in one embodiment, the exposure controller 910 is configured to be able to adjust the exposure level(s) of the infrared-spectrum portion of the dual-spectrum digital video camera 920 in dependence on the exposure level(s) of the visible-spectrum potion of the dual-spectrum digital video camera 920. For example, in one embodiment, the exposure controller 910 includes a look-up-table (LUT) stored in memory that relates a selected exposure level of the visible-spectrum portion of the dual-spectrum digital video camera 920 to an exposure level of the infrared-spectrum portion of the dual-spectrum digital video camera 920. In this manner, when an exposure level(s) is selected for the visible-spectrum portion of the dual-spectrum digital video camera 920, an exposure level(s) for the infrared-spectrum portion of the dual-spectrum digital video camera 920 is effectively selected as well. Dependencies between the exposure levels of the visible-spectrum portion of the dual-spectrum digital video camera 920 and the infrared-spectrum portion of the dual-spectrum digital video camera 920 can be determined by experimentation for various welding processes.

In one embodiment, the vision engine 170 is configured to increase a dynamic range of image data within a resultant dual-spectrum real-time digital video image frame by combining at least two of the raw visible-spectrum real-time digital video image frames, acquired at different exposure levels, into a single visible-spectrum image frame. Therefore, when the vision engine 170 combines the single visible-spectrum image frame (formed from image frames at multiple exposures) with an infrared-spectrum image frame, the resultant dual-spectrum image frame will have a larger dynamic range due to the larger dynamic range of the single visible-spectrum image frame (formed from image frames at multiple exposures).

Similarly, in accordance with another embodiment, the vision engine 170 is configured to increase a dynamic range of image data within a resultant dual-spectrum real-time digital video image frame by combining at least two of the raw infrared-spectrum real-time digital video image frames, acquired at different exposure levels, into a single visible-spectrum image frame. Therefore, when the vision engine 170 combines the single infrared-spectrum image frame (formed from image frames at multiple exposures) with a visible-spectrum image frame, the resultant dual-spectrum image frame will have a larger dynamic range due to the larger dynamic range of the single infrared-spectrum image frame (formed from image frames at multiple exposures).

Furthermore, in accordance with yet another embodiment, the vision engine 170 is configured to increase a dynamic range of image data within a resultant dual-spectrum real-time digital video image frame by combining at least two of the raw infrared-spectrum real-time digital video image frames, acquired at different exposure levels, into a single infrared-spectrum image frame, and by combining at least two of the raw visible-spectrum real-time digital video image frames into a single visible-spectrum image frame. Therefore, the resultant dual-spectrum image frame will have a larger dynamic range due to both of the larger dynamic ranges of the constituent single infrared-spectrum image frame and the single visible-spectrum image frame.

In one embodiment, the exposure controller 910 includes an exposure control analyzer 915 configured to operate on the raw visible-spectrum real-time digital video image frames and the raw infrared-spectrum real-time digital video image frames which are fed back to the exposure controller 910 from the dual-spectrum digital video camera 920. In accordance with one embodiment, the adjustment of exposure level is performed based on an analysis, by the exposure control analyzer 915, of the image frames fed back to the exposure controller 910 from the dual-spectrum digital video camera 920. The exposure control analyzer 915 may be implemented within the exposure controller 910 in the form of, for example, hardware (e.g., logic circuits or a digital signal processor), software (e.g., computer-executable instructions running on a processor), firmware (e.g., a programmable and addressable memory, such as an EEPROM, storing a look-up-table (LUT)), or some combination thereof.

For example, in one embodiment, as image frames from the dual-spectrum digital video camera 920 are fed back to the exposure controller 910 in real-time, the exposure control analyzer 915 analyzes the image data within the image frames and determines a distribution of the image data within the image frames. A distribution may be formed from image data (e.g., pixel data) for a single image frame or from data over multiple images frames, in accordance with various embodiments. A distribution characterizes the frequency of occurrence of some characteristic of the image data being analyzed. In accordance with one embodiment, a distribution characterizes the frequency of occurrence of amplitudes of the image data being analyzed. In accordance with another embodiment, a distribution characterizes the frequency of occurrence of colors of the image data being analyzed. Other types of distributions are possible as well, in accordance with various other embodiments.

Once the exposure control analyzer 915 determines a distribution, the exposure controller 910 can adjust an exposure level of the corresponding portion (visible or infrared) of the dual-spectrum digital video camera 920 based on the distribution. For example, one type of distribution may indicate that the exposure level needs to be increased to achieve the overall desired dynamic range selected by the user via the user interface 310. Another type of distribution may indicate that the exposure level needs to be decreased to achieve the overall desired dynamic range selected by the user via the user interface 310. The relationships between image data distributions and exposure levels can be determined experimentally or analytically, for example. In this manner, as image frames are being acquired in real-time by the dual-spectrum digital video camera 920, the exposure levels can be adjusted in real-time based on the characteristics of the actual image data being captured. As a result, a desired dynamic range can be maintained for any or all of the visible-spectrum real-time digital video image frames, the infrared-spectrum real-time digital video image frames, or the dual-spectrum real-time digital video image frames.

In one embodiment, as image frames from the dual-spectrum digital video camera 920 are fed back to the exposure controller 910 in real-time, the exposure control analyzer 915 analyzes the image data within the image frames and determines statistical parameters (e.g., mean, variance, standard deviation) of the image data within the image frames. Statistical parameters may be formed from image data (e.g., pixel data) for a single image frame or from data over multiple images frames, in accordance with various embodiments. A statistical parameter characterizes some statistical characteristic of the image data being analyzed. In accordance with one embodiment, statistical parameters characterize the mean, variance, and/or standard deviation of amplitudes of the image data being analyzed. In accordance with another embodiment, statistical parameters characterize the means, variance, and/or standard deviation of colors of the image data being analyzed. Other types of statistical parameters and characterizations are possible as well, in accordance with various other embodiments.

Once the exposure control analyzer 915 determines the statistical parameters, the exposure controller 910 can adjust an exposure level of the corresponding portion (visible or infrared) of the dual-spectrum digital video camera 920 based on the statistical parameters. For example, one type of statistical parameter may indicate that the exposure level needs to be increased to achieve the overall desired dynamic range selected by the user via the user interface 310. Another type of statistical parameter may indicate that the exposure level needs to be decreased to achieve the overall desired dynamic range selected by the user via the user interface 310. The relationships between image data statistical parameters and exposure levels can be determined experimentally or analytically, for example. In this manner, as image frames are being acquired in real-time by the dual-spectrum digital video camera 920, the exposure levels can be adjusted in real-time based on the characteristics of the actual image data being captured. As a result, a desired dynamic range can be maintained for any or all of the visible-spectrum real-time digital video image frames, the infrared-spectrum real-time digital video image frames, or the dual-spectrum real-time digital video image frames.

In accordance with an alternative embodiment, analysis of the image frames may be performed by the vision engine 170 instead of by an exposure control analyzer 915 within the exposure controller 910. In such an embodiment, the vision engine 170 may simply provide the analytical results (e.g. distribution information, statistical information) to the exposure controller 910 on a frame-by-frame basis in real-time.

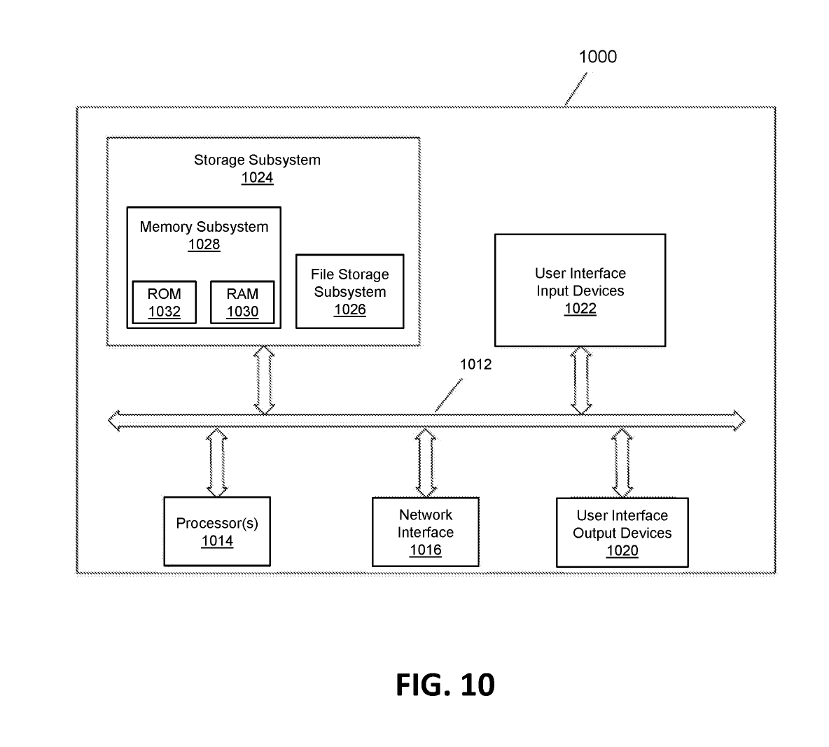

FIG. 10 illustrates an embodiment of an example exposure controller 1000 that may be used as the exposure controller 810 and 910 in the systems of FIG. 8 and FIG. 9. The controller 1000 includes at least one processor 1014 which communicates with a number of peripheral devices via bus subsystem 1012. These peripheral devices may include a storage subsystem 1024, including, for example, a memory subsystem 1028 and a file storage subsystem 1026, user interface input devices 1022, user interface output devices 1020, and a network interface subsystem 1016. The input and output devices allow user interaction with the controller 1000. Network interface subsystem 1016 provides an interface to outside networks and is coupled to corresponding interface devices in other computer systems. For example, a computerized welding power source may share one or more characteristics with the controller 1000 and may include, for example, elements of a conventional computer, a digital signal processor, and/or other computing device.

User interface input devices 1022 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into the controller 1000 or onto a communication network.

User interface output devices 1020 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from the controller 1000 to the user or to another machine or computer system.

Storage subsystem 1024 stores programming and data constructs that provide some or all of the controller functionality described herein. For example, the storage subsystem 1024 may include one or more software modules including computer executable instructions for analyzing image data and adjusting exposure levels.

These software modules are generally executed by processor 1014 alone or in combination with other processors. Memory subsystem 1028 used in the storage subsystem can include a number of memories including a main random access memory (RAM) 1030 for storage of instructions and data during program execution and a read only memory (ROM) 1032 in which fixed instructions are stored. A file storage subsystem 1026 can provide persistent storage for program and data files, and may include a hard disk drive, a floppy disk drive along with associated removable media, a CD-ROM drive, an optical drive, or removable media cartridges. The modules implementing the functionality of certain embodiments may be stored by file storage subsystem 1026 in the storage subsystem 1024, or in other machines accessible by the processor(s) 1014.

Bus subsystem 1012 provides a mechanism for letting the various components and subsystems of the controller 1000 communicate with each other as intended. Although bus subsystem 1012 is shown schematically as a single bus, alternative embodiments of the bus subsystem may use multiple buses.

The controller 1000 can be of various implementations including a single computer, a single workstation, a computing cluster, a server computer, or any other data processing system or computing device configured to perform the controller functions described herein. Due to the ever-changing nature of computing devices and networks, the description of the controller 1000 depicted in FIG. 10 is intended only as a specific example for purposes of illustrating some embodiments. Many other configurations of the controller 1000 are possible having more or fewer components than the controller depicted in FIG. 10.

In summary, arc welding systems, methods, and apparatus that provide dual-spectrum, real-time viewable, enhanced user-discrimination between arc welding characteristics during an arc welding process are disclosed herein. Camera exposure levels can be automatically adjusted in real-time to affect the dynamic range of image data displayed to a user.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or illustrative examples shown and described. Thus, this disclosure is intended to embrace alterations, modifications, and variations that fall within the scope of the appended claims, which satisfy the statutory subject matter requirements of 35 U.S.C. § 101. The above description of specific embodiments has been given by way of example. From the disclosure given, those skilled in the art will not only understand the general inventive concepts and attendant advantages, but will also find apparent various changes and modifications to the structures and methods disclosed. It is sought, therefore, to cover all such changes and modifications as fall within the spirit and scope of the general inventive concepts, as defined by the appended claims, and equivalents thereof.

What is claimed is:

1. A dual-spectrum digital imaging arc welding system, said system comprising:
a welding headgear configured to be worn on a head of a user and to shield at least the eyes of the user from spectral radiation emitted by an arc welding process;
a visible-spectrum digital video camera physically integrated with the welding headgear and configured to provide raw visible-spectrum real-time digital video image frames;
an infrared-spectrum digital video camera physically integrated with the welding headgear and configured to provide raw infrared spectrum real-time digital video image frames;
an exposure controller operatively interfacing with the visible-spectrum digital video camera and the infrared-spectrum digital video camera, wherein the exposure controller is configured to adjust at least one of:
(i) an exposure level of the visible-spectrum digital video camera, on a frame-by-frame basis in real-time in accordance with an exposure control algorithm executed by the exposure controller, or
(ii) an exposure level of the infrared-spectrum digital video camera, on a frame-by-frame basis in real-time in accordance with the exposure control algorithm executed by the exposure controller;
an optical display assembly physically integrated with the welding headgear and configured to present real-time digital video images to the user while the user is wearing the welding headgear; and
a vision engine operatively interfacing with the visible-spectrum digital video camera, the infrared-spectrum digital video camera, and the optical display assembly, wherein the vision engine is configured to generate at least one of:
(i) dual-spectrum real-time digital video image frames from the raw visible-spectrum real-time digital video image frames and the raw infrared-spectrum real-time digital video image frames,
(ii) enhanced visible-spectrum real-time digital video image frames from the raw visible-spectrum real-time digital video image frames, or
(iii) enhanced infrared-spectrum real-time digital video image frames from the raw infrared-spectrum real-time digital video image frames.

2. The system of claim 1, wherein the exposure controller is configured to adjust the exposure level of the visible-spectrum digital video camera independently of adjusting the exposure level of the infrared-spectrum digital video camera.

3. The system of claim 1, wherein the exposure controller is configured to adjust the exposure level of the visible-spectrum digital video camera in dependence on the exposure level of the infrared-spectrum digital video camera.

4. The system of claim 1, wherein the exposure controller is configured to adjust the exposure level of the infrared-spectrum digital video camera in dependence on the exposure level of the visible-spectrum digital video camera.

5. The system of claim 1, wherein the exposure controller is configured to adjust the exposure level of the visible-spectrum digital video camera by controlling an adjustment of at least one of an exposure time, an f-number, a sensitivity, or an optical filter of the visible spectrum digital video camera.

6. The system of claim 1, wherein the exposure controller is configured to adjust the exposure level of the infrared-spectrum digital video camera by controlling an adjustment of at least one of an exposure time, an f-number, a sensitivity, or an optical filter of the infrared-spectrum digital video camera.

7. The system of claim 1, wherein the vision engine is configured to increase a dynamic range of image data within a dual-spectrum real-time digital video image frame of the dual-spectrum real-time digital video image frames by combining at least two of the raw visible-spectrum real-time digital video image frames, acquired at different exposure levels, into a single visible-spectrum image frame.

8. The system of claim 1, wherein the vision engine is configured to increase a dynamic range of image data within a dual-spectrum real-time digital video image frame of the dual-spectrum real-time digital video image frames by combining at least two of the raw infrared-spectrum real-time digital video image frames, acquired at different exposure levels, into a single infrared-spectrum image frame.

9. The system of claim 1 further comprising a user interface operatively interfacing to at least the exposure controller and configured to allow a user to manually select a dynamic range from a plurality of selectable dynamic ranges, wherein the dynamic range specifies a range of image data to be generated within at least the dual-spectrum real-time digital video image frames.

10. A dual-spectrum digital imaging arc welding system providing enhanced discrimination between arc welding characteristics to a user, said system comprising:
a welding headgear configured to be worn on a head of a user and to shield at least the eyes of the user from spectral radiation emitted by an arc welding process;
a dual-spectrum digital video camera physically integrated with the welding headgear and configured to provide raw visible-spectrum real-time digital video image frames and raw infrared-spectrum real-time digital video image frames;
an exposure controller operatively interfacing with the dual-spectrum digital video camera, wherein the exposure controller is configured to adjust at least one exposure level of the dual-spectrum digital video camera on a frame-by-frame basis in real-time based at least in part on image data within image frames fed back to the exposure controller from the dual-spectrum digital video camera;
an optical display assembly physically integrated with the welding headgear and configured to present real-time digital video images to the user while the user is wearing the welding headgear; and
a vision engine operatively interfacing with the dual-spectrum digital video camera and the optical display assembly, wherein the vision engine is configured to generate at least one of:
(i) dual-spectrum real-time digital video image frames from the raw visible-spectrum real-time digital video image frames and the raw infrared-spectrum real-time digital video image frames,
(ii) enhanced visible-spectrum real-time digital video image frames from the raw visible-spectrum real-time digital video image frames, or
(iii) enhanced infrared-spectrum real-time digital video image frames from the raw infrared-spectrum real-time digital video image frames.

11. The system of claim 10, wherein the exposure controller is configured to adjust an exposure level of a visible-spectrum portion of the dual-spectrum digital video camera on a frame-by-frame basis in real-time based on an exposure control analyzer of the exposure controller operating on the raw visible-spectrum real-time digital video image frames fed back to the exposure controller from the dual-spectrum digital video camera.

12. The system of claim 10, wherein the exposure controller is configured to adjust an exposure level of an infrared-spectrum portion of the dual-spectrum digital video camera on a frame-by-frame basis in real-time based on an exposure control analyzer of the exposure controller operating on the raw infrared-spectrum real-time digital video image frames fed back to the exposure controller from the dual-spectrum digital video camera.

13. The system of claim 10, wherein the exposure controller is configured to adjust an exposure level of a visible-spectrum portion of the dual-spectrum digital video camera independently of adjusting an exposure level of an infrared-spectrum portion of the dual-spectrum digital video camera.

14. The system of claim 10, wherein the exposure controller is configured to adjust an exposure level of the visible-spectrum portion of the visible-spectrum digital video camera in dependence on an exposure level of the infrared-spectrum portion of the infrared-spectrum digital video camera.

15. The system of claim 10, wherein the exposure controller is configured to adjust an exposure level of the infrared-spectrum portion of the infrared-spectrum digital video camera in dependence on an exposure level of the visible-spectrum portion of the visible-spectrum digital video camera.

16. The system of claim 10, wherein the exposure controller is configured to adjust an exposure level of a visible-spectrum portion of the dual-spectrum digital video camera by controlling an adjustment of at least one of an exposure time, an f-number, a sensitivity, or an optical filter of the visible-spectrum portion of the dual-spectrum digital video camera.

17. The system of claim 10, wherein the exposure controller is configured to adjust an exposure level of an infrared-spectrum portion of the dual-spectrum digital video camera by controlling an adjustment of at least one of an exposure time, an f-number, a sensitivity, or an optical filter of the infrared-spectrum portion of the dual-spectrum digital video camera.

18. The system of claim 10, wherein the vision engine is configured to increase a dynamic range of image data within a dual-spectrum real-time digital video image frame of the dual-spectrum real-time digital video image frames by combining at least two of the raw visible-spectrum real-time digital video image frames, acquired at different exposure levels, into a single visible-spectrum image frame.

19. The system of claim 10, wherein the vision engine is configured to increase a dynamic range of image data within a dual-spectrum real-time digital video image frame of the dual-spectrum real-time digital video image frames by combining at least two of the raw infrared-spectrum real-time digital video image frames, acquired at different exposure levels, into a single infrared-spectrum image frame.

20. The system of claim 10 further comprising a user interface operatively interfacing to at least the exposure controller and configured to allow a user to manually select a dynamic range from a plurality of selectable dynamic ranges, wherein the dynamic range specifies a range of image data to be generated within at least the dual-spectrum real-time digital video image frames.
